(19) United States
(12) Patent Application Publication
(10) Pub. No.: US 2004/0251656 A1
(43) Pub. Date: Dec. 16, 2004

(54) Lift and transfer chair

(76) Inventors: Richard A. Patterson, Georgetown, TX (US); Alan D. Patterson, Austin, TX (US)

Correspondence Address: Jack V. Musgrove, 2911 Briona Wood Lane, Cedar Park, TX, 78613, US

(21) Appl. No.: 10/460,602

(22) Filed: Jun. 12, 2003

(51) Int. Cl. B62J 1/00

(52) U.S. Cl. 280/304.1

(57) ABSTRACT

A transfer chair has a chair frame, a seat, wheels, and a lift arm which has an articulated path between home and target positions. The articulated path may define a limited clearance height to allow use with, e.g., cars having a small door opening. In one embodiment the seat is split and moves to allow passage of the lift arm as it travels along the articulated path. The lift arm is articulated such that a lifting bridle attached to a distal end of the lift arm is maintained in a constant angular orientation with respect to the chair frame during movement. The lift arm further has multiple deployment paths for target positions with different heights and distances. A transfer seat for the lift arm includes two flexible webs removably attached to the lifting bridle. The lift arm is constructed using four links which are pivotally connected end-to-end. The links can be folded to a stowed position within the chair frame. An actuation mechanism uses a lead-screw actuator coupled to one of the links which lifts the remaining links by rotation about its pivotal attachment to the chair frame, and similarly uses another lead-screw actuator coupled to the next link. The actuation mechanism can be operated by an on-board motion control computer for controlling the trajectory and velocity of the arm. Sensors provide trajectory information to the on-board computer, and a docking switch can select one of a plurality of target trajectories for deploying the lift arm. A docking station integrated with the frame mates with a docking feature on the target object and stabilizes the chair while transferring the user. The docking station may include a receptacle for electrical connection to a power supply. A more comprehensive transfer system is provided using a path sensor which tracks a sensible path proximate the target object, and an electronic controller responsive to the path sensor which operates the drive wheels to follow the sensible path to a stowage location. The transfer chair drive wheels may be caregiver-operated using throttle handlebars.

### BACKGROUND OF THE INVENTION

1. Field of the Invention

The present invention generally relates to mobility enhancement systems for physically challenged individuals, and more particularly to wheelchairs which allow the user to transfer himself or be transferred to a position adjacent the wheelchair.

2. Description of the Related Art

In the United States alone, there are over 2 million physically challenged individuals who are confined to wheelchairs due to illness, accidents or degenerative diseases. While about half of these people are able to stand on their own, the remaining half are unable to support their weight on their legs. Approximately 80% of people using wheelchairs are cared for in their own homes, while the remainder are cared for in nursing homes, hospice facilities, rehabilitation centers and hospitals.

Handicapped people who are unable to stand or otherwise lift their weight with their arms face many difficulties in their daily lives. One of the most serious of these is that they must be frequently lifted and transferred between their wheelchairs and their beds, regular chairs, dining facilities, bathroom fixtures, cars, etc. In nursing homes for example, it is estimated that patients must be lifted and transferred 10 to 15 times per day depending on their illness and physical condition.

Lifting and moving these individuals usually is done by family members, friends or professional care givers in home care situations, and by trained nurses or therapists in institutional settings. Occasionally, commercially available lifting aids are employed to assist with patient lifting, but because of limitations and ease of use issues, most patient lifting and transfers are done manually. Whenever disabled individuals are lifted or moved, there is a possibility for injuring that person. These injuries usually result when the patient is bumped into objects while being lifted and transferred, or from being dropped.

When caregivers manually lift and transfer patients, they can seriously injure their backs. Often the patient being lifted is significantly heavier than the care giver, and cannot assist the care giver during the move. Some patients also move erratically while being moved, and may slip out of the care givers grasp, or force the care giver to quickly readjust their lifting position. Lifting and moving patients is, however, part of the expected activities for nurses and caregivers. If they are unable to perform these functions due to lifting injuries to the back, they may be required to work in other capacities in the health care system, or to find other jobs. The loss of skilled experienced nurses and care givers in nursing homes, hospitals, and hospice institutions reduces the overall quality of healthcare delivered.

In nursing homes in some states, formal reports must be written each time a patient is injured no matter what the reason. These reports are then reviewed with the nursing home management and corrective action is taken. The reporting process and subsequent review sessions, although worthwhile, result in significant additional effort and cost on the part of the nursing institution. In home care settings, a significant portion of the cost of caring for a seriously handicapped individual is the cost of care givers who are required to safely lift and move the patient. Providing an alternative means for lifting and transferring the patient would then enable family members or friends to provide for more of the patient's healthcare needs. This could reduce the cost of in home patient care over extended periods of time.

Another problem confronted by people with serious physical disabilities is the occurrence of pressure or bed sores when the patient is allowed to remain in one position for extended periods of time. Pressure sores are painful and very difficult and expensive to cure. A system that made it easier for patients to be moved could increase the frequency of patient moves, and thus reduce the occurrence of pressure sores.

Many individuals who are seriously handicapped due to accidents or illness were active, self supporting people prior to the onset of their handicap. It is often difficult for challenged people to make the transition from being totally independent, to being highly or totally dependent on caregivers for the most basic functions. Handicapped individuals must deal with the pain and suffering associated with their illness on a day to day basis. At the same time, they also face the loss of independence and self sufficiency that they once enjoyed. The combination of these two factors can lead to the onset of serious depression in the individual, and thus reduce the rate of their recovery. Providing a means to enable the handicapped individual to be more self sufficient, and more independent, could significantly enhance the individuals quality of life, reduce their dependence on professional caregivers, and thus reduce the cost of care for that person.

There are several mechanized patient lift and transfer systems currently being sold for handicapped individuals and their care givers. However, these devices and systems have serious short comings, and do not address the total need associated with safely lifting, transferring, and transporting handicapped individuals within their daily living and healthcare environments. One device commonly used is a hydraulically operated hoist or crane in which the patient is supported in a flexible sling. This device consists of a pivoted arm mounted to a base containing casters. The arm is moved by a hydraulic cylinder, and the patient lifting sling is attached to the end of the arm with a lifting bridle and chain.

The hydraulic patient lift is operated by a care giver, and not by the patient. The device is normally located next to a bed, or in a bathroom, and is used to lift the patient from bed to a wheelchair and back, or from a wheelchair to a bathroom or bath fixture and back. It does not go with the patient as the patient moves between rooms and certainly does not go not outside of buildings.

These lifting/hoist devices are normally equipped with casters. Although it would be possible to move the patient hoist between lifting locations, these types of lifting devices are awkward to move, and are designed primarily for use in one location. Thus for a patient being lifted in multiple rooms, it would be most convenient to have one lifting system for each location where a patient might need to be lifted and transferred. The devices are relative large, and take a considerable amount of floor space.

Since the lifting device is outfitted with casters, it would also be possible to move the patient between rooms while hanging from the end of the hoist. However this can be demoralizing and degrading for patients to be dangling from the end of a chain in a sling while being moved in public places, and this form of patient transport is normally not done.

Another significant disadvantage of hoist devices is that the lift starting position, patient's trajectory or path during the move, uniformity of motion, and end landing position are all controlled manually by the care giver. Even if the care giver is well-trained, it is relatively easy for the care giver to cause the patient to collide with stationary objects during lifts and transfers, and even drop the patient at the end of the move.

One final disadvantage of lifting hoists is that they are not designed so the user cannot operate the hoist themselves. Thus, handicapped individuals who are seeking greater independence from caregivers still will require another person to operate the lifting hoist style patient transfer device.

Another patient lift and transfer system is available for use in homes and institutional settings, referred to as an overhead hoist/trolley system, which also has significant limitations and drawbacks. It consists of a set of tracks that are permanently attached to the ceiling of rooms in a home or institution. A trolley rides on the track that contains an electrically powered chain hoist. The track is located on the ceiling directly above the patient's bed and possibly above a chair in a bed room for example. Separate sections of track can also be installed on the ceiling in hallways, bathrooms, kitchens, etc. Each section of track in each room contains its own separate trolley device with lifting hoist.

With such a system, the patient is lifted in a sling or rigid harness that connects to a hook at the bottom of the lifting hoist. This lifting hoist is attached to and supported by the trolley riding on the overhead track. After the patient is lifted by the hoist and their weight is supported on the trolley, the trolley can be moved away for the lifting position toward a second target position such as a wheelchair. The system is capable of moving a patient from bed to a wheelchair for example, but since the overhead track is not continuous with other rooms (due to dropped headers above doors), the patient must use a different lifting hoist and track section to be lifted from the wheelchair in another room. This means that the patients lifting sling must be disconnected and reconnected to the lifting hoist in each new room where a patient transfer is required. It is clearly not possible to transfer a patient in any indoor or outdoor location where the overhead lifting track is not in place. Thus the overhead track system could not be used for transferring a patient from his wheelchair into a car for example.

Another limitation of the track patient lift system relates to installation of the system in a home or institution. The lifting system and patient can weigh up to 400 lbs, which may require reinforcement of the ceiling to which the tracks are attached. Each section of track must contain its own lifting trolley and hoist since tracks cannot pass under door headers in adjacent rooms. Finally, like floor model hydraulic lifting hoists, the overhead system depends on the training and dexterity of the care giver to move the patient smoothly and safely. There are opportunities for patients to be bumped and dropped with this system since the lifting path and end target are established manually.

Other devices are also coming into the market that enhance a patient's mobility and independence. These devices are referred to as “standers”, and they enable a user or individual who is seated to be able to rise to a standing position. They do not however enable a patient to be lifted and transferred between wheelchairs, furniture, cars, and the like.

Based on the foregoing, it would be desirable to devise an improved lift system for physically challenged individuals which allow the user to be transferred to a position adjacent the wheelchair, without all of the limitations and drawbacks of the foregoing devices. It would be further advantageous if the system could precisely and accurately move the individual without injury or discomfort from the starting position to the end position.

### SUMMARY OF THE INVENTION

It is therefore one object of the present invention to provide an improved system for easily, safely, and precisely lifting and transferring individuals between their wheelchairs, and their beds, other chairs, bathroom fixtures, cars, etc.

It is another object of the present invention to provide such a system which can be operated not only by caregivers, but also by individual users who have the capability and desire to provide more of their own care.

It is yet another object of the present invention to provide a lift and transfer chair which is able to transport patients in a dignified manner both within and outside their daily living environment.

The foregoing objects are achieved in the patient lifting and transferring system of the present invention which, in the illustrative embodiment, is comprised of a computer controlled, electrically powered patient lifting arm mechanism with a detachable and collapsible patient support and transfer seat, all mounted in a push or electrically-powered wheelchair. The patient transfer seat is integrated with the chair's comfortable fully adjustable seat containing arm rests. The lifting arm mechanism, when not in use, folds completely inside and under the wheelchair, and is not visible. The chair is approximately the same width and length as a conventional electric wheelchair. The chair's mechanical arm transfers the user laterally to the side of the chair, and can very accurately and repeatedly place the user at a target that is from 18 to 36 inches from the floor, and up to 36 inches offset from the center of the chair. The path of travel of the end of the mechanical arm and thus the path of the user are controlled by the chair's onboard computer. Each lifting and transfer path may be preprogrammed into the chair's computer by a technician, or downloaded from the Internet. The path is selected to provide maximum smoothness and safety for the user during the lift from the chair, the traverse to the target position, and then the descent onto the target position.

The initial position for starting the patient move onto a bed, into an arm chair, into a car seat, or onto a bathroom fixture may be precisely established by a docking station. Sensors in the mechanical arm provide feedback to the computer controlling the motion of the arm drive motors, thus enabling the lifting arm to precisely lift, transfer, and unload the user at a final position to within an accuracy of ±½″. Precise movement of the patient significantly reduces patient injuries associated with manual lifting or lifting by the current lift systems.

The user is supported during the lift in a collapsible seat that can easily be removed from under the user either when in the chair, or when at the target position in bed, in a chair, or on a bathroom fixture. The transfer seat and patient do not swing or dangle from mechanical arm as occurs with the hydraulic lift hoist or trolley lifting systems. Rather, the seat is steady and fully supported from tipping or rocking by the lifting arm mechanism. The patient can however rotate about a vertical pivot where the transfer seat lifting bridle attaches to the mechanical arm. This feature is useful in the event the patient's preferred orientation at the target position is not parallel to his orientation in the chair. Seat stability during patient moves and transfers also reduces patient injuries.

The chair can be either electrically propelled like a standard electric wheelchair, or can be manually pushed like a standard wheelchair. The electrically powered version can be either controlled by a joystick by the patient, or can be controlled by the caregiver with a self-propelled mechanism. The chair may contain onboard batteries and a charger for powering the chair drive motors, and/or the electrically powered lifting arm. Alternatively, electrical power for the lifting arm can be provided from another source such as via the docking station. The chair may utilize safety sensors that stop or safely re-orient the system if required. These sensors can be located around the chair to ensure that none of the patients or caregivers extremities come into contact with the lifting mechanism.

The docking station system may include a female receiver portion that is integral with the chair, and corresponding male plug portions that are attached to each location where the user may be transferred, e.g., his bed, furniture, bathroom fixtures, and the user's car. The plug and receiver portions of the docking station are mounted the same distance from the floor, and engage one another as the chair moves adjacent and parallel to its lifting target. When this occurs, the plug portion on the target slides inside the receiver portion of the docking station that is attached to the chair. The main functions of the docking station are to accurately locate the chair in relationship to its lifting target to facilitate precisely controlled user transfers, lock the chair to the target in order to prevent the chair from tipping during lateral user transfers, provide electrical power to the chair for operating the lifting arm for chairs without batteries and for recharging batteries in chairs that contain batteries, and provide information to the chair's arm control computer concerning the move distance and trajectory between the chair and the target.

The present invention significantly improves the level of independence and dignity of handicapped individuals by reducing their reliance on caregivers for lifting and moving, while reducing the number of lift and move related injuries to handicapped individuals both in home care and institutional care settings, and reducing the number of back injuries to care givers associated with lifting and moving patients.

The above as well as additional objectives, features, and advantages of the present invention will become apparent in the following detailed written description.

### BRIEF DESCRIPTION OF THE DRAWINGS

The present invention may be better understood, and its numerous objects, features, and advantages made apparent to those skilled in the art by referencing the accompanying drawings.

FIG. 1 is a perspective view of one embodiment of a lift and transfer chair constructed in accordance with the present invention, with the lift arm and links stowed;

FIG. 2 is a left side elevational view of the lift and transfer chair of FIG. 1, with the lift arm and links stowed;

FIG. 3 is a front elevational view of the lift and transfer chair of FIG. 1, with the lift arm and links stowed;

FIG. 4 is a left side elevational view of the lift and transfer chair of FIG. 1, with the lift arm and links in an initial deployed position wherein the user is still seated in the chair;

FIG. 5 is a front side elevational view of the lift and transfer chair of FIG. 1, with the lift arm and links in the initial deployed position;

FIG. 6 is a front side elevational view of the lift and transfer chair of FIG. 1, with the lift arm and links in an intermediate deployed position wherein the user is raised above the chair;

FIG. 7 is a front side elevational view of the lift and transfer chair of FIG. 1, with the lift arm and links in a terminal deployed position wherein the user is located adjacent the chair;

FIG. 8 is a detailed elevational view of one embodiment of drive mechanisms for the links which support and move the lift arm of the lift and transfer chair of FIG. 1;

FIG. 9 is a perspective view of the lift and transfer chair of FIG. 1, shown fully deployed and illustrating one embodiment of a foldable lifting seat;

FIG. 10 is a high-level schematic diagram of an electronic control system for use with the lift and transfer chair of FIG. 1; and

FIG. 11 is a schematic view of one implementation of a sensible path in accordance with the present invention which is used in conjunction with a vehicle having a docketing station that receives the lift and transfer chair of FIG. 1, wherein the sensible path is used to automatically stow and retrieve the chair.

The use of the same reference symbols in different drawings indicates similar or identical items.

### DESCRIPTION OF THE PREFERRED EMBODIMENT(S)

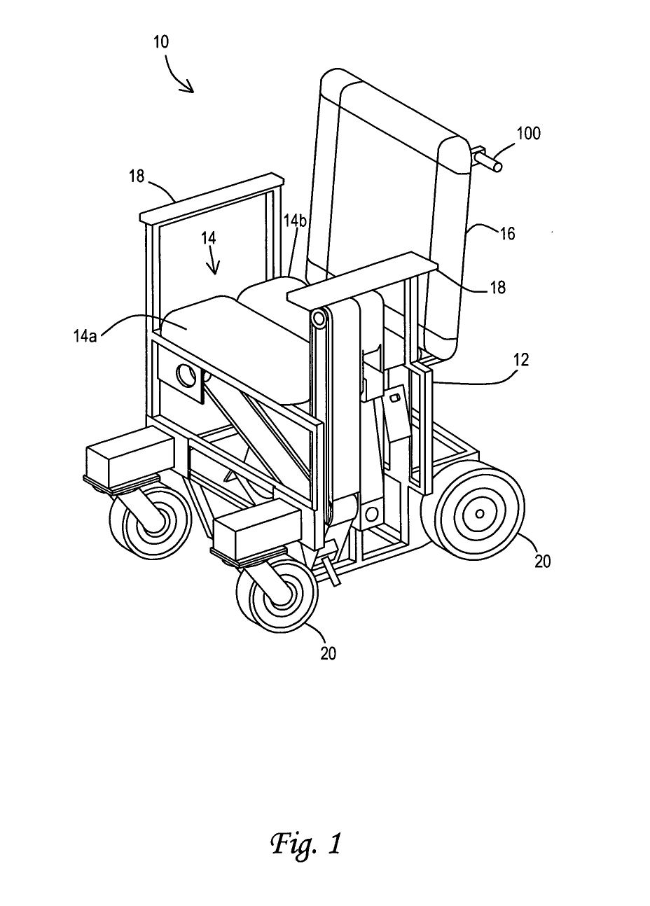

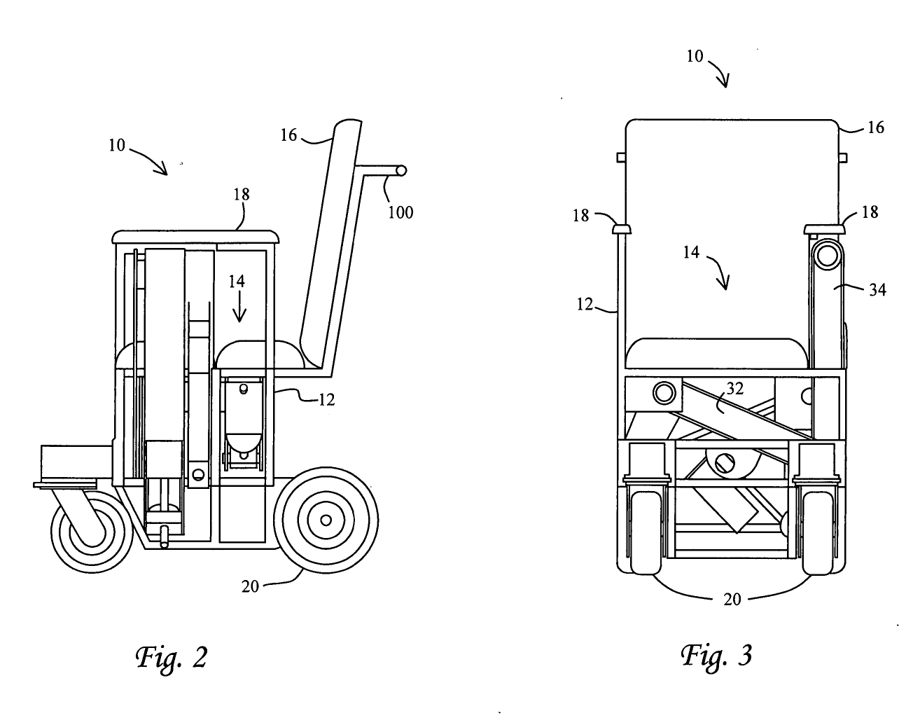

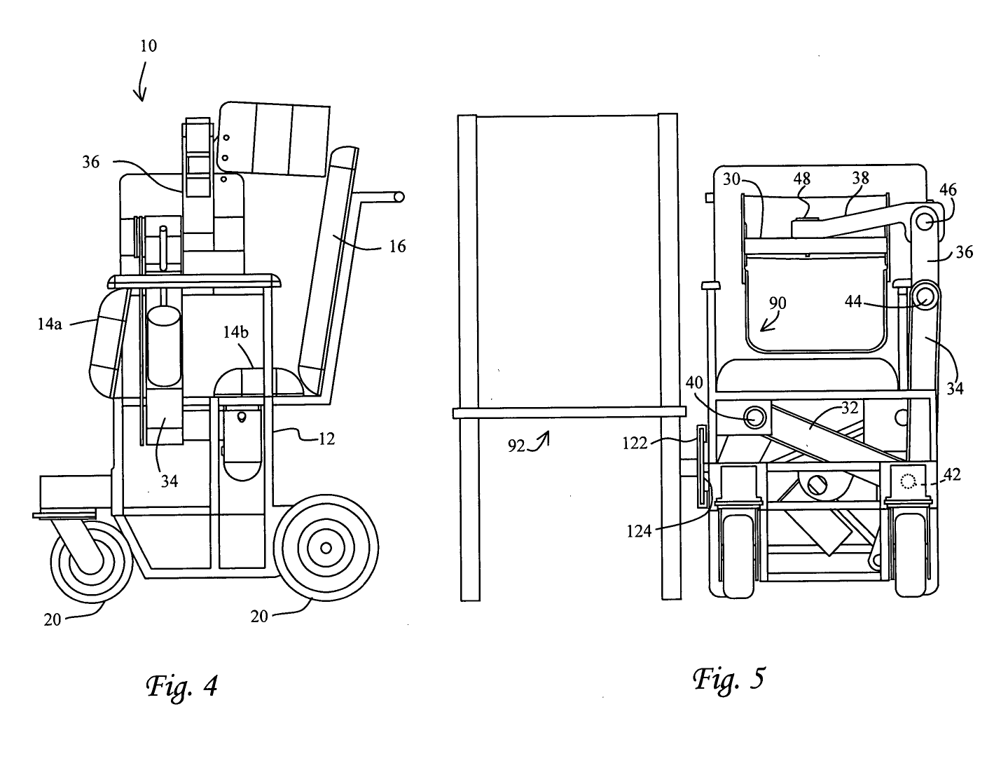

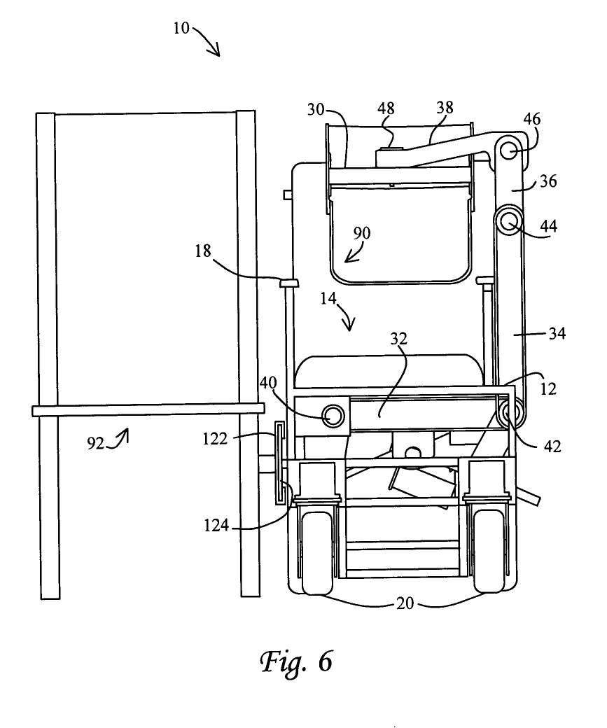

With reference now to the figures, and in particular with reference to FIGS. 1-3, there is depicted one embodiment 10 of a lift and transfer chair constructed in accordance with the present invention. Lift transfer chair 10 is generally comprised of a chassis or frame 12, a seat 14 attached to frame 12, a chair back 16 attached to frame 12, arm rests 18 attached to frame 12, and wheels 20 operably mounted to frame 12. Lift transfer chair 10 also has a lift mechanism which is in a stowed position and accordingly not visible in FIGS. 1-3, but is further discussed in conjunction with FIGS. 4-7. The outside of the chair chassis is covered by panels for the user's safety, and for protection of and access to internal components. In the illustrative embodiment, the lift transfer chair is designed to fit through a 24 inch door opening, and has the same approximate outside dimensions as currently available electric wheelchairs (23.5 inches wide×30 inches long×36 inches high). This embodiment has an electric drive (i.e., motor and gears) to impel chair 10 so wheels 20 are relatively small, but a manual drive version can be designed with larger rear wheels which the user physically pushes.

Frame 12 is preferably constructed using rectangular steel tubing weldment that locates and supports all of the chair's internal components. The outside chair access panels also attach to the base frame. The main structural member in the chassis weldment is an open ended 2″×6″ rectangular steel tube that is located along one side of the chassis, and above the front and rear wheels. This main tube may also function as half of the docking station system to prevent the chair from tipping when the user's weight is transferred laterally to the side of the chair as will be described later.

Referring now to FIGS. 4-7, the lift mechanism of lift transfer chair 10 generally includes a lifting bridle 30, a series of arm links 32, 34, 36, 38, and one or more drive mechanisms coupled to frame 12. The lift mechanism may be controlled electronically, described further below. The four links 32, 34, 36, 38 are connected end-to-end through single-axis pivot pin joints, and provide an articulated path for the lifting bridle between a home position proximate the seat of chair 10 and a target position adjacent to one side of chair 10. Link 32 has one end attached to chassis 12 at pivot pin 40, and the other end attached to one end of link 34 at pivot pin 42. The other end of link 34 is attached to one end of link 36 at pivot pin 44. The other end of link 36 is attached to one end of link 38 through pivot pin 46. The axes of pivot pins 40, 42, 44 and 46 are each perpendicular to the longitudinal axes of each of the links 32, 34, 36 and 38. The distal end of link 38 is attached to a foldable user lifting seat bridle 30 at pivot pin 48, whose axis is perpendicular to the axes of pivot pins 40, 42, 44 and 46. The axes of pivot pins 40, 42, 44 and 46 are always parallel to one another during operation of the lifting arm assembly.

While the lift mechanism could be manually powered using, e.g., hand cranks, the preferred embodiment uses an electric drive. During deployment of the lift mechanism, link 32 is caused to rotate through an arc of approximately 100 degrees about pivot pin 40 and with respect to the chair chassis by a first motor-operated lead-screw actuator 50. Link 34 is caused to rotate through an arc of approximately 90 degrees about pivot pin 42 and with respect to link 32 by a second motor-operated lead-screw actuator 52. In their stowed storage or home positions, the axis of link 32 is oriented approximately at a 30 degree angle to horizontal with its first end above its second end, and link 34 is oriented generally vertically.

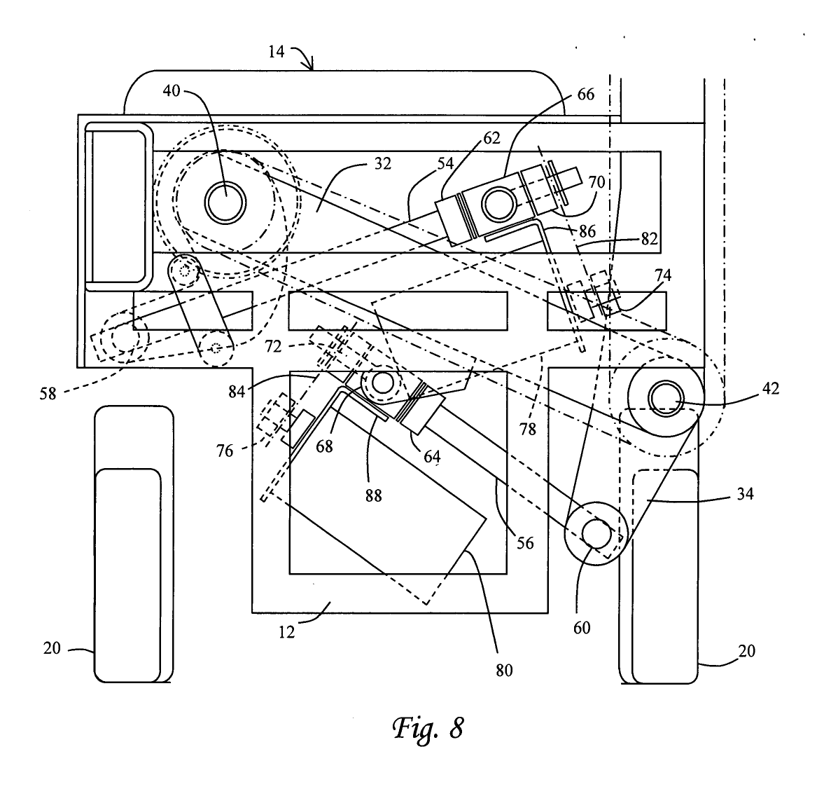

The two lead-screw drive actuator units are generally identical and are shown in more detail in FIG. 8 (some foreground and background features have been omitted in FIG. 8 to facilitate viewing of the actuation mechanisms). Each actuator 50, 52 has a 1 inch diameter, 10-pitch lead screw 54, 56. One end of each lead screw 54, 56 operates inside of, and through a ball nut block 58, 60. Each ball nut block contains two pivot posts that project from opposite sides of the block. The axes of these posts are perpendicular to the axis of the particular screw 54, 56 operating through the respective nut block 58,60. The other end of each lead screw is reduced in diameter and contains no threads. These ends pass through respective thrust collars 62, 64 and thrust block assemblies 66, 68 that each contain a set of roller radial and thrust bearings. The reduced diameter ends of the lead screws also extend beyond the thrust blocks, and are rigidly secured inside respective driven chain sprockets 70, 72. These sprockets are coupled to respective drive sprockets 74, 76 on gear drive motors 78, 80 by drive chains 82, 84. The lead screws can rotate within the thrust blocks on the radial bearings. Thrust loads generated during operation of the lead screws are transmitted from the lead screws through the thrust collars and thrust bearings on one side of the blocks, and through the driven sprockets and thrust bearings on the other side of the blocks. The thrust blocks also contains pivot posts at opposite ends that project from each block perpendicular to the axis of the respective lead screw bearing bore.

The motors are mounted to the thrust blocks with adjustable brackets 86, 88, and rotate the lead screws through the sprocket/chain drive. The thrust blocks attach through the pivot posts and clevis arrangements to either the chassis of the chair or a lever extension of the respective link 32, 34. The motor used in the illustrative embodiment is a reversible in-line brushless gear head DC motor, such as the 29 RPM 24 volt motors sold by Bodine Corp. of Illinois. As the drive motor is rotated in one direction, the associated lead screw is rotated through the sprocket chain connection to the motor, and the nut block moves along the lead screw toward the thrust block. As the motor rotates in the opposite direction, the nut block moves away from the thrust block. These lead screw actuator designs are capable of generating several thousand pounds of thrust.

The first end of link 32 also contains a torque tube and dual plate drive lever that is welded to the body of link 32. Pivot pin 40 passes through the center of this torque tube, and supports link 32 and the offset plate drive levers on bronze bushings at each end of the torque tube. The ends of pivot pin 30 are secured to the chair chassis. The dual plate drive levers operate in a plane that is parallel to the plane of operation of link 32, and offset from it by approximately 8 inches. This offset provides clearance for mounting the first lead screw actuator.

The nut end of the first lead screw actuator attaches through its pivot posts and clevis arrangement to the offset dual plate lever that is part of link 32. The thrust block end of the first actuator 50 attaches through its pivot posts and clevis arrangement to the chassis of the chair. Thus when the first lead screw actuator drive motor 78 is rotated clockwise, lead screw 54 rotates, and pulls the drive nut toward the thrust block. This action causes link 32 to rotate about pivot pin 40 upward from its home position to a position of up to 100 degrees from home. Motor 78 preferably has a drive ratio of approximately 20.4:1.

The first end of link 42 contains a pair of lever plates that project in a direction that is opposite to the main body of link 34 and beyond pivot pin 42. A line connecting the clevis bores at the end of the parallel lever plates on link 42 to the bore for pivot pin 42 is offset from the center axis of link 34 by approximately 30 degrees. The nut end of the second lead screw actuator attaches through its pivot posts and clevis arrangement to these lever plates on the first end of link 34. The thrust block end of the first actuator attaches through its pivot posts and clevis arrangement to a pair of attachment plates that are welded to the side of link 32. Thus, when the second lead screw actuator drive motor 80 is operated clockwise, lead screw 56 rotates, and pulls the drive nut toward the thrust block. This action causes link 34 to rotate about pivot pin 42 generally away from its home position with respect to link 32. Rotating lead screw 56 the opposite direction (counterclockwise) causes the nut to move away from the thrust block, and thus causes link 34 to rotate about pivot pin 42 generally toward link 32. Total rotational arc of motion of link 34 with respect to link 32 is approximately 90 degrees. Motor 80 preferably has a drive ratio of approximately 29.7:1.

Link 38 and its attached lifting bridle 30 are allowed to rotate with respect to link 36 between two stop positions. The first stop position is utilized when the lifting arm is deployed, i.e., lifting and transferring a user from the chair to a target position. The second stop position is used when link 36 and 38 are stowed inside the chair. Links 36, 38 and the lifting bridle 30 form a link assembly that is always maintained in a constant (the same) angular orientation with respect to the chair frame no matter what the angular orientation of links 32 and 34, due to the following construction. Pivot pin 44 is rigidly attached to the first end of link 36, and pivots in the second end of link 34. A 50-pitch 17-tooth sprocket is also rigidly attached to pivot pin 42 on the opposite side of link 34 from link 36. This sprocket is connected by a chain loop to the first plate of a double 50-pitch, 17-tooth sprocket that is supported on bushings on pivot pin 42. The second plate of the double sprocket is connected to a chain loop to another 50-pitch, 17-tooth sprocket that is supported on bushings on pivot pin 40. This sprocket is rigidly attached to a 5.50 inch diameter drive gear. The drive gear contains a projection on one side that contacts an adjustment screw that prevents the gear from rotating more than 240 degrees with respect to a fixed stop point on the chair chassis. A 1 inch diameter pinion gear also engages the 5.5 inch gear and causes it to rotate up to 240 degrees between stop positions. The drive pinion is rotated through a sprocket and chain drive arrangement by a right angle DC gear motor 81 that is mounted to the chassis of the chair. Motor 81 preferably has a drive ratio of approximately 20.4:1.

When the arm is in its lifting position (FIG. 5), link 36 is generally vertical, and link 38 is generally horizontal with the lifting connection bridle located under link 38. The projection on one side of the 5.5 inch diameter drive gear is in contact with the chair chassis stop, and is prevented from rotating. Since the sprockets on pivot pins 42 and 44 are chain connected to the 5.5 inch drive gear through the sprocket that is attached to the gear, the rotational orientation of the links 36, 38, and bridle assembly 30 is all controlled by the angular orientation of the drive gear. When the gear is rotated by its drive motor, and links 32 and 34 are held fixed by their lead screw drive actuators 50, 52, the link 36, 38 assembly will rotate about the second end of link 34. However, when link 32 is rotated with respect to the chair chassis and link 34 is rotated with respect to link 32, and the 5.5 inch drive gear is held fixed with respect to the chair chassis, the links 36, 38 will remain in the same angular orientation as the chair frame no matter where the second end of link 34 is positioned in space.

When link 38 is in its normal lifting (deployed) position, and the 5.5 inch drive gear is against its stop on the chair chassis, link 38 is generally horizontal, and link 36 is generally perpendicular to the floor. No matter where links 32 and 34 are rotated, link 38 will remain horizontal during deployment, and link 36 will remain vertical. The articulated path of the lifting arm preferably defines a clearance height of no more than about 42 inches. This limited clearance allows the user to be transferred through a car door opening into a vehicle without interference.

When the links are not being used and are to be stored in the side of the chair under the arm rest, link 38 is rotated away from its lifting stop position, and to a storage stop that is 90 degrees from the lifting stop position. In this storage or stowed position, the axes of links 36 and 38 are generally aligned, with link 38 projecting straight beyond link 36. Rotation of link 38 and lifting bridle 30 is performed manually by the user or caregiver after the user is seated in the chair's transfer seat 90, as described in the next paragraph. With links 32 and 34 held fixed in their normal home position inside the base and arm of the chair, the 5.5 inch drive gear can be rotated approximately 180 degrees. This rotation causes links 36 and 38 to rotate with respect to link 34 to the storage position that is along side of link 34, and under the arm rest 18 of chair 10.

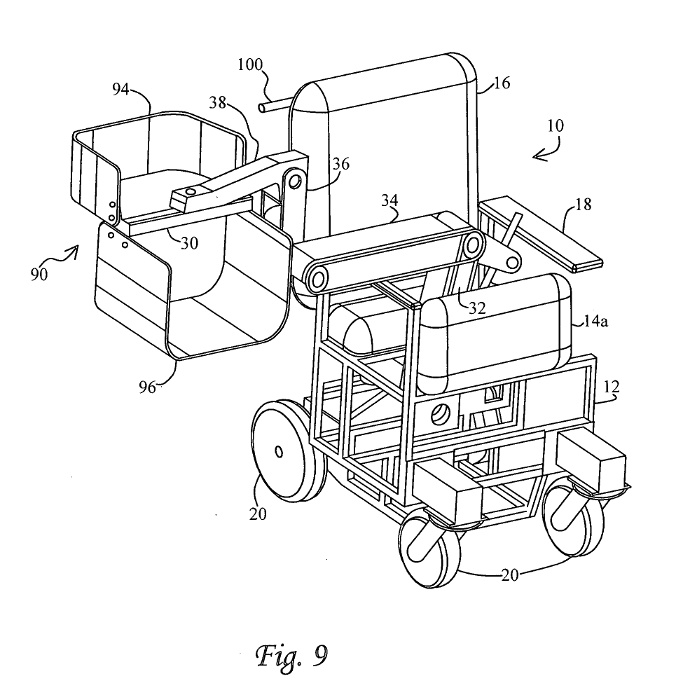

With further reference now to FIG. 9, the user is supported during lifts and transfers in a foldable lifting and transfer seat 90 that is removably attached to lifting bridle 30, which is pivotally attached to the second end of link 38 on the arm. Transfer seat 90 provides improved support and stability for the compared to conventional lifting slings used with hoists and trolley transfer systems. In this embodiment, transfer seat 90 consists of two 6 to 8 inch wide flexible webs 94, 96. The first ends of each of these webs are attached to a first pair of metallic connection plates. The second ends of each of the webs are attached to a second pair of metallic connection plates. Each pair of the metallic web connection plates contain means (such as a square post on the end of one plate and matching square hole for the post on the end of the other plate) for temporarily joining the plates to form a single “L” shaped plate. When flexible webs have been attached to the right and left pair of connecting plates, and each set of plates are joined to form single “L” shaped plates, the final assembly is similar in shape and function to a canvas “director's” chair with web seat and back.

In the normal lifting position of transfer seat 90, the bottom or underlying web of the seat rests against the lower cushion 14 of the chair's permanent seat, and the back or rear web of the transfer seat is in contact with the back cushion 16 of the permanent seat. The user is sitting on top of the transfer seat so that the bottom web is located under the upper thigh portion of the legs and part of the buttocks, while the back portion is resting against the central and lower back. When the user is sitting on the lifting seat and the permanent chair seat 14, the left “L” shaped plate assembly is located adjacent the users left side with the intersection between the legs of the “L” being located slightly above his left hip. At the same time, the right “L” shaped plate assembly is located adjacent the users right side with the intersection between the legs of the “L” being located slightly above his right hip.

The “L” shaped web connection plate assemblies also have means for quickly and easily connecting and disconnecting them to the ends of lifting bridle 30 that extends across and slightly above the user's lap when seated in the chair. When the “L” shaped plate assemblies are attached to the ends of the lifting bridle, the lifting seat assembly is prevented from rocking or swinging in any direction by its connection to the lifting arm through the lifting bridle. The lifting seat can however pivot about the vertical pivot 48 located between lifting bridle 30 and the second end of link 38 on the lifting arm. This pivoting action enables the user to rotate his position slightly with respect his original position the chair during or at the end of a lift and transfer.

When the user has been moved either to of from the chair, it may be useful to remove the lifting seat from under the user. This is done in the following way. First, the lifting bridle is removed from each of the right and left “L” shaped plate assemblies located adjacent the users hips. If necessary, link 38 is manually pivoted upward to its normal storage position and locked in place. The two “L” shaped connecting plate assemblies are then disconnected at their anti-rotation joint. At this point, the bottom web of the seat and the back web of the seat are no longer connected together. The bottom web and its end connection plates can then be easily slid from under the users legs, and the back web and its connection plates can be easily pulled upward from behind that users back. Reinstallation of the seat under the user (who is either in chair 10 or in bed, another chair, etc.) is accomplished by reversing the above procedure.

The permanently mounted user seat consists of a lower seat cushion 14, back cushion 16, and arm rests 18. The lower seat cushion is comprised of two cushion segments 14a and 14b. The rear segment 14b is permanently affixed to the chair chassis. The front segment 14a is hinged along its front edge, and pivots upward toward the front of chair 10. This hinge is used to provide clearance for the lifting arm links as they pivot upward from their home position under cushion 14. The rotational motion of link 32 is used to push seat front 14a to its vertical position by a set of linkages attached to link 32 and front pivoted seat segment 14a. The seating system on the chair can also contain special adjustability, lifting, and reclining features as desired. Adjustable foot rests may also be provided on the front of the chair to support the weight of the user's feet and lower legs.

Chair 10 may be manually pushed or motor propelled. For a manually pushed chair, the rear wheels would free-wheel, and not be attached to any drive source. The rear wheels of the chair might contain brakes for slowing or parking the chair. The front wheels of the chair would be pivoted casters, and would be able to easily turn in any direction. For electrically-propelled versions of the chair, each rear wheel is driven by its own variable-speed reversible DC gear motor. These gear motors may to connected directly to each rear wheel, or may be remotely mounted in the chassis, and drive the rear wheels of the chair through chain and drive sprockets.

Two different chair motor drive control systems can be utilized with powered drive wheels. The first control system utilizes a joystick or similar user-operated control input device. With this system the user can directly control the direction and speed of the chair. It is possible to alternatively (or additionally) equip the chair with a caregiver-operated control system which operates the electric wheel drive. That system is configured so that pushing or twisting a pair of handlebars 100 that are mounted behind and above the back cushion 16 signals the motor drive control system to run both wheel drive motors forward. Pulling back or reverse twisting handlebars 100 causes the wheel drive motors to reverse, and the chair to move backward. Turning a given one of the throttle handlebars to one side causes a corresponding one of the drive motors to drive its wheel faster than the other, thus making the chair turn the desired direction. Sharper turns can be managed by actuating one wheel drive motor to drive forward, while the other motor is stopped or reversed. The throttle handlebars could be constructed to allow variable motor speeds. This caregiver-operated drive system could be retrofitted to existing wheelchairs.

Chair 10 can be equipped with rechargeable storage batteries for operating the lifting arm and the chair drive motors. The storage batteries are mounted in a rack 102 at the back of the chair behind and slightly below the upper seat cushion. The batteries can be recharged either by an external charger, or though an electrical connection in the docking station described below. Two 12-volt batteries connected in series provide a 24 volt power supply for the 24 volt DC gear head drive motors and the control system.

The manually pushed version of the chair can also be set up with no on board battery power. In this case, the lifting arm would operate directly from a power supply source provided through the docking station, when the chair is engaged with the mating portion of the docking station.

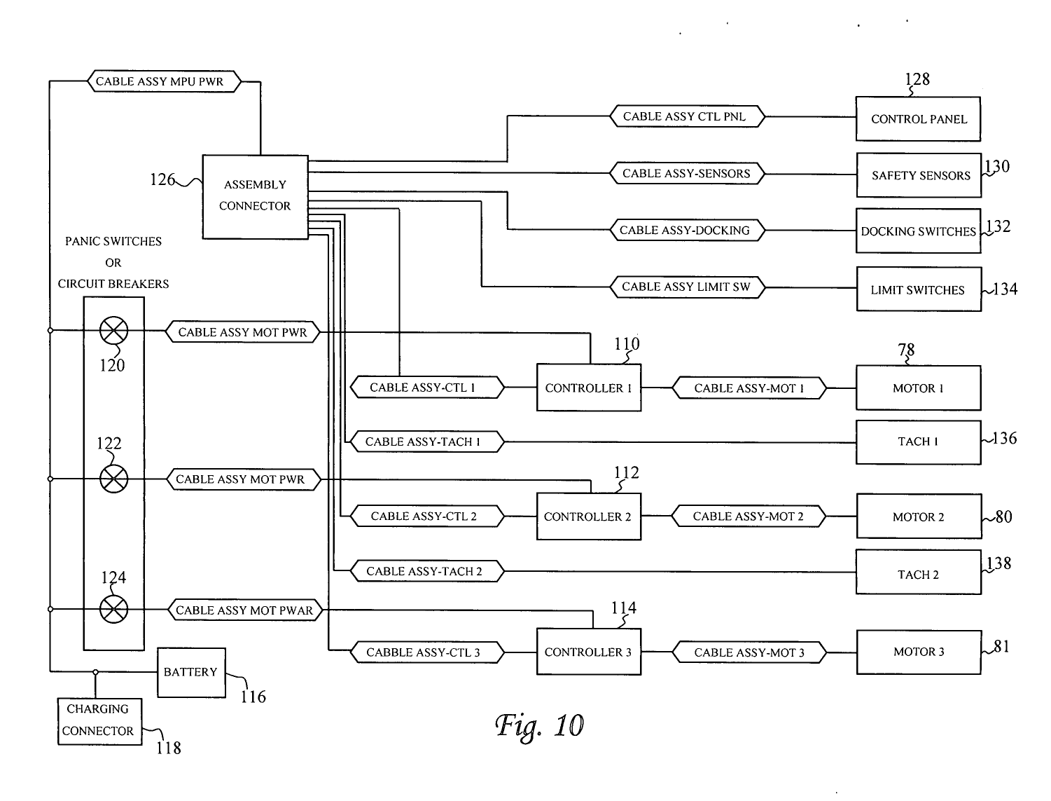

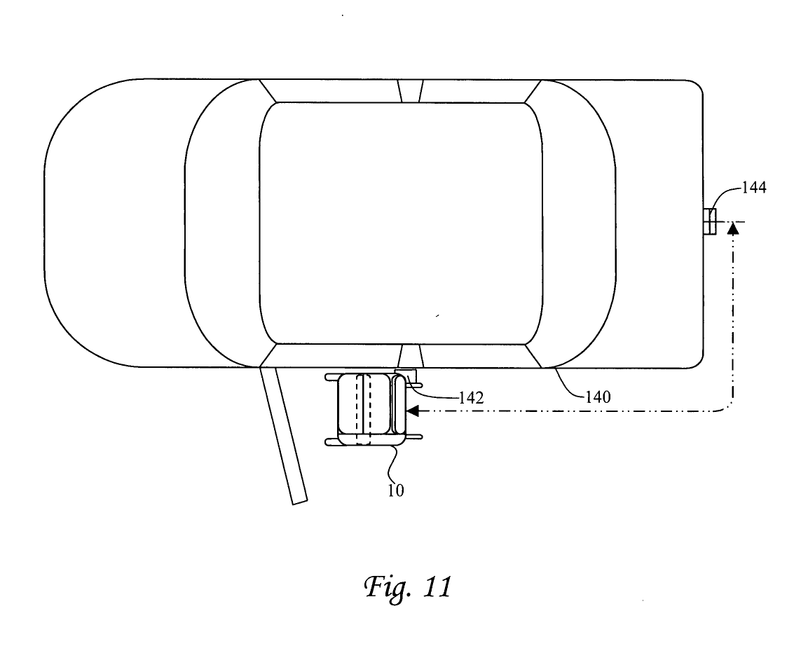

An exemplary electronic control system for chair 10 is shown FIG. 10. Several microcontrollers 110, 112 and 114 are provided to operate the various motors that are used in deploying the lifting arm linkages. Bodine model 3907 brushless DC motor controllers may be used. Each of these microcontrollers is supplied with power via a rechargeable battery 116 (12-volt, deep draw). A connection 118 is provided for recharging battery 116 by means of an external power source (i.e., 110 volt AC wall outlet). Circuit breakers and/or panic switches 120, 122 and 124 may be interposed along the connections from the power supply to the motors.

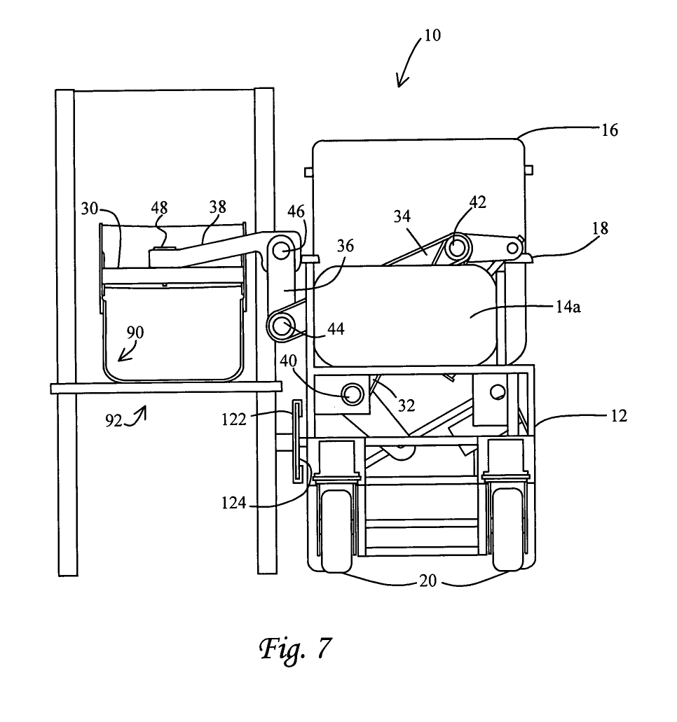

Power is also supplied to a connector module 126 which provides interconnections between the microcontrollers and various switch and sensor inputs. These inputs may include operator input switches 128, safety sensors 130, docking station switches 132, and limit switches 134. In the illustrative embodiment, the operator input switches are located on a control panel conveniently located near one of the armrests 18, and may be mounted on a base that pivots or swivels to move out of the user's way when not needed. Operator input switches 128 may include an Unfold switch, a Start switch, a Return switch, a Stop switch, a Home switch, a Store switch, and a Jog switch. The Unfold switch activates the controllers to unfold the upper section of the lifting arm assembly from the side of chair 10, to the position shown in FIG. 5. The Start switch moves the patient from chair 10 to target 92, as shown in FIG. 7. The Return switch moves the patient back from target 92 to chair 10. The Stop switch acts as an emergency stop to interrupt motion of the lifting arm assembly until one of the other motion switches is activated. The Home switch moves the empty arm to the home position after deploying the patient to target (the onboard computer differentiates the Home switch from the Return switch so that safety sensors can be used to check for any weight on the arm before starting the move). The Store switch moves the upper section of the lifting arm assembly back to storage position under arm rest 18 of chair 10. The Jog switch moves the empty arm from the home position toward a patient waiting at the target position, allowing partial moves of the arm. The operator control panel may also include a visual indicator, such as a light-emitting diode (LED), to show a fully charged status of the battery.

Safety sensors 130 are utilized to provide input signals to the arm movement controllers and alert the controller of potential problems with the lift/transfer cycle. Other sensors or encoders can provide positional information to the computer to verify the arm's position at all points in the lift path. The safety sensors may include a Hand sensor, an Arm Weight sensor, a Seat Weight sensor, three Arm Contact sensors, and a Web sensor. The Hand sensor is activated when the patient's hands are safely in position for grasping the harness lift bar 30. These sensors can be placed on the upper side of the lifting bridle. The user's hands apply pressure to the sensors and activate them. If this pressure is removed, the arm would stop. The Arm Weight sensor is activated when the patient's weight is supported on the lifting arm. The Seat Weight sensor indicates whether any weight is pressing down on seat 14. The Arm Contact sensors indicate if any of the arm linkages comes into contact with an unknown object (the controller would then immediately stop the arm movement). For example, one arm contact sensor may be located in the lifting bridle to sense if the bridle contacts an object (e.g., the patient's legs) which would create a slight upward pressure on the bridle. The Web sensor informs the controllers that the lower and back webs of lifting seat 90 are properly attached to the lifting bridle.

The docking switches 132 are used in conjunction with the docking station described in conjunction with FIG. 11 and may include, e.g., four switches that are activated by repositionable pins in the target portion of the docking station, described further below.

The limit switches 134 include a Docked switch, several Program Path Selection switches, and several Link Arm switches. The Docked switch is activated when chair 10 is fully engaged and seated in the docking station. The Program Path Selection switches identify which particular pre-programmed path is to be followed. In the illustrative embodiment, there are four program path switches corresponding to four pins of a 4-pin array located in the docking station. The controllers have the capability of storing up to 12 different arm deployment paths, and can be programmed with new path information either from a computer (e.g., a PC), or from a telephone line. Four Link Arm switches may be provided, to indicate the positional status of link arms 32, 34, 36 and 38.

Rotary encoders 136, 138 can monitor the movement of the screw motors 78, 80. The encoders provide further input to the controllers, which are programmed to control the speed and direction of the DC gear motors that drive the two lead screw actuators, to smoothly and safely follow a prescribed lift, transfer, and descend path. In each user transfer, the start or home position from which the user is to be moved is known because the chair is locked to the bed, chair, car, etc. (generally referred to as “target” 92 in FIGS. 5-7) at a known position through the docking station. The docking station tells the arm motion control computer that it is locked to a specific piece of furniture, and what the move parameters should be for that lift, transfer, and descend. For example, if the user is to be moved from the chair to an arm chair, the horizontal position of the seat of the arm chair is known with respect to the home position of the chair, and the height of the target arm chair cushion is also known. In this case, the arm control computer would direct the drive motors to lift the user upward out of the chair seat, to smoothly transition to a horizontal path from the chair to the target, and then to smoothly transition to a descending path directly above the arm chair cushion. The arm 48 would lower the user until it reached its target position, and sensors in the arm told the computer that the user's weight was being supported by the arm chair. Transfer seat 90 is then disconnected from lifting bridle 30, and unfolded and removed from under and behind the user.

Various cable assemblies are used to interconnect the elements of the electronic control system for chair 10.

Referring now to FIG. 11, lift and transfer chair 10 may be combined with a docking station which is part of a target, such as a car, to provide a more comprehensive patient lift transfer system. The docking station functions in this patient lift transfer system are to prevent the chair from tipping when a user is being transferred between the chair and a target piece of furniture, car, bath room fixture etc., to provide a very precise home or starting position for the user lift and transfer to ensure that the lift, transfer and descent are smooth and safe for the user, and that the user arrives precisely at the target unload position, to provide information to the chair concerning the type of lift to be made including the lift/transfer/descent parameters, and the exact target position, to protect the user from being moved along the incorrect path or to the wrong target and prevent user injuries, and to provide electrical power for recharging batteries in the chair or to operate the drive motors in the lift arm directly for chairs with no on-board power supply.

In the preferred embodiment, the docking station system contains a female receiver portion 122 that is permanently attached to the frame of the car (or chair, bed, etc.), and located along the side of the target opposite from the side in which upper portion of the lifting arm is stored on chair 10. In the illustrated construction, female receiver portion 122 comprises a socket or slot that is formed using a steel members. A male plug portion 124 integrated with chair 10 may take the form of a steel plate which then slides into female receiver 122. With this arrangement, the chair can be docked either by moving forward adjacent the target, or by moving backward adjacent the target depending on the most favorable layout of the user's living quarters or other environment.

Depending on the functions desired in the docking station (e.g., passive or electrically active) the plug portion may require its own low voltage electrical power source. Information about the type of target that the chair is docking with can be provided in a number of ways including, but not limited to, a mechanical pin array that is read by the receiver during the docking motion, a pre-recorded magnetic stripe and reader system that is read during the docking sequence, or a punched photo mask read by an optical reader during docking. When the docking station plug slides inside the receiver during the docking motion, it may also be useful to engage a locking pin between the plug and receiver. This pin can prevent the chair from accidentally moving with respect to the target during transfers. The fit between the plug and receiver is such that they easily engage with one another, but rotational movement of the receiver about the plug is prevented. To make the engagement between plug and receiver smoother, the plug and/or receiver may be Teflon coated.

The docking station on the chair (or the docking feature on the target object) may also include a transmitter, e.g., radio wave, that provides status information to a central monitoring unit to allow an administrator to remotely supervise the status of patient transfers.

The lift transfer system shown in FIG. 11, specifically adapted for usage with a vehicle, may further include means for loading and stowing chair 10 on the vehicle after the user has been transferred into the vehicle. A sensible path 140 is formed along one side of the vehicle, and is perceived by chair 10 by means of an additional path sensor 142 located on the chair, adjacent the same side of chair 10 as the car. The sensible path may take the form of any machine-sensible medium, including but not limited to optical, magnetic, or tactile features, such as markers which are adhered to the side of the car along an intended path toward a stowing location. After the user has been transferred to the car, the user can signal the chair (via the control panel) to automatically track and follow the sensible path around the car, to the stowage position at the rear end of the car. One of the electronic controllers may be programmed to appropriately operate the electric wheel drive of the chair responsive to the path sensor. A chair lift 144 or other docking device is then used to raise the chair off the ground and secure it to the vehicle for transport.

Although the invention has been described with reference to specific embodiments, this description is not meant to be construed in a limiting sense. Various modifications of the disclosed embodiments, as well as alternative embodiments of the invention, will become apparent to persons skilled in the art upon reference to the description of the invention. It is therefore contemplated that such modifications can be made without departing from the spirit or scope of the present invention as defined in the appended claims.

What is claimed is:

1. A transfer chair comprising:
a chair frame;
a seat attached to said chair frame;
wheels operably mounted along a bottom of said chair frame; and
a lift arm pivotally attached to said chair frame and having an articulated path between a home position proximate said seat and a target position adjacent to a side of said chair frame.

2. The transfer chair of claim 1 wherein the articulated path defines a clearance height of no more than 42 inches.

3. The transfer chair of claim 1 wherein said seat is split into two or more portions, and at least one of said split seat portions moves to allow passage of said lift arm as it travels along the articulated path.

4. The transfer chair of claim 1 further comprising a lifting bridle attached to a distal end of said lift arm, said lift arm being articulated such that said lifting bridle is maintained in a constant angular orientation with respect to said chair frame during movement along the articulated path.

5. A transfer chair comprising:
a chair frame;
a seat attached to said chair frame;
wheels operably mounted along a bottom of said chair frame; and
a lift arm coupled to said chair frame and having multiple deployment paths between a home position proximate said seat and target positions with different heights and distances relative to said home position.

6. The transfer chair of claim 5 wherein said chair frame is no wider than 24 inches.

7. The transfer chair of claim 5 wherein said lift arm comprises a plurality of linkage members which fold away to a stowed position within said chair frame.

8. A transfer chair comprising:
a chair frame;
a seat attached to said chair frame;
wheels operably mounted along a bottom of said chair frame; and
a lift arm having first, second, third and fourth linkage members, said first linkage member having a first end pivotally attached to said chair frame and a second end pivotally attached to a first end of said second linkage member, said second linkage member having a second end pivotally attached to a first end of said third linkage member, and said third linkage member having a second end pivotally attached to a first end of said fourth linkage member.

9. The transfer chair of claim 8 further comprising an actuation mechanism coupled to said linkage members which folds said third and fourth linkage members from a deployed position over said seat to a stowed position clear of said seat when said first and second linkage members are located in a stop position within said chair frame.

10. The transfer chair of claim 8 wherein said first linkage member is coupled to a first lead-screw actuator which lifts said second end of said first linkage member by rotating said first linkage member about its pivotal attachment to said chair frame.

11. The transfer chair of claim 10 wherein said second linkage member is coupled to a second lead-screw actuator which locates said second end of said second linkage member by rotating said second linkage member about its pivotal attachment to said first linkage member.

12. A transfer chair comprising:
a chair frame;
a seat attached to said chair frame;
wheels operably mounted along a bottom of said chair frame;
a lift arm coupled to said chair frame for transferring a user to a target position;
an actuation mechanism for moving said lift arm; and
one or more electronic controllers which operate said actuation mechanism to deploy said lift arm.

13. The transfer chair of claim 12, further comprising a control panel mounted to said chair frame allowing the user to provide input to said one or more electronic controllers.

14. The transfer chair of claim 12, further comprising one or more sensors attached to said lift arm which provide trajectory information to said one or more controllers.

15. The transfer chair of claim 12, further comprising one or more docking switches indicating which of a plurality of target trajectories is to be used by said one or more controllers in deploying said lift arm.

16. A transfer chair comprising:
a chair frame;
a chair seat attached to said chair frame;
wheels operably mounted along a bottom of said chair frame;
a lift arm coupled to said chair frame for transferring a user to a target position; and
a transfer seat attached to said lift arm, said transfer seat including at least two flexible webs, one of said webs having an underlying orientation and another of said webs having a rear orientation.

17. The transfer chair of claim 16 wherein said transfer seat is removably attached to said lift arm.

18. The transfer chair of claim 16 wherein said lift arm includes a lifting bridle, said transfer seat being removably attached to said lifting bridle.

19. A transfer chair comprising:
a chair frame;
a seat attached to said chair frame;
wheels operably mounted along a bottom of said chair frame;
a lift arm coupled to said chair frame for transferring a user to a target position proximate a target object; and
a docking station attached to said chair frame, said docking station adapted to mate with a docking feature on the target object and thereby stabilize said chair frame while transferring the user to the target position.

20. The transfer chair of claim 19 wherein said docking station includes one or more docking switches which indicate a trajectory for transferring the user to the target position.

21. The transfer chair of claim 19 wherein said docking station includes a power receptacle for electrical connection to a power supply.

22. The transfer chair of claim 19 further comprising:
a path sensor which tracks a sensible path proximate the target object;
means for impelling said wheels; and
an electronic controller responsive to said path sensor which operates said impelling means to follow the sensible path to a stowage location.

23. A transfer chair comprising:
a chair frame;
a seat attached to said chair frame;
wheels operably mounted along a bottom of said chair frame;
means for impelling said wheels; and
one or more handlebars located on a rear side of said chair frame for operating said impelling means.

24. The transfer chair of claim 23, further comprising a lift arm coupled to said chair frame for transferring a user to a target position.

25. The transfer chair claim 23 wherein:
a left throttle handlebar is used to control a left drive wheel; and
a right throttle handlebar is used to control a right drive wheel.
